(19) United States
(12) Patent Application Publication
(10) Pub. No.: US 2011/0006134 A1
(43) Pub. Date: Jan. 13, 2011

(54) ADAPTABLE SHOWER SYSTEM AND METHOD

(76) Inventors: CARL D. PARKS, Woodstock, GA (US); BRYAN D. SHAW, Powder Springs, GA (US); JASON TYLER CLARK, Dallas, GA (US); JERONE R. KOLLBAUM, Canton, GA (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 12/832,680

(22) Filed: Jul. 8, 2010

Related U.S. Application Data
(60) Provisional application No. 61/224,025, filed on Jul. 8, 2009.

(51) Int. Cl. B05B 1/14

(52) U.S. Cl. 239/548

(57) ABSTRACT

A shower head unit having at least one preferably rain like shower head, where the rain like shower head is connect to a support member for an overhead shower. The support member is adapted to be positioned between opposing walls of a bath tub, stall enclosure or outdoor shower having preferably a wall water pipe and a wall shower head attached to the wall water pipe. The support member is a pipe that has first and second ends and a nipple adapted to be coupled to the wall water pipe near the first end for carrying shower water to the rain like shower head and is located above the wall shower head.

### TECHNICAL FIELD

The present invention relates generally to a shower for bath tub, stall enclosure and/or outdoor showers and more particularly to a shower for a bath tub, stall enclosure and/or outdoor shower that has one or more shower heads located overhead to provide preferably a rain shower effect where the multiple heads are installable subsequent to the installation of the existing equipment.

### BACKGROUND

At the present time there are various shower systems for use with bath tubs and stall enclosures which are installed in the walls by a plumber that directs one or more spray streams of water to a user's body. These systems are normally expensive to install and require the use of a licensed plumber. One particular shower-head style that is highly desirable is the overhead rain-like shower system. However, this type of arrangement typically requires additional internal wall plumbing to allow the source of water to be channeled to the roof of the shower and thus to the shower head. This added costs can be significant and as such, most people can only enjoy this type of system while staying at upscale hotels.

What is needed is a shower system that has one or more overhead shower heads that can be easily installed by a home owner to an existing wall shower head which is both easy to use and can be controlled to provide a rainlike body spray pattern.

### SUMMARY OF THE INVENTION

There is disclosed a rain-like shower head unit that can be connected to an existing wall shower head to provide, in combination with the existing wall shower head, an overhead shower where each of which can be selectively controlled.

A home owner, to install the disclosed rain-like shower head unit does not require the services of a licensed plumber nor are new internal wall pipes required. To install the preferred embodiment, the home owner only has to position the one piece combination of shower heads across the top of the bath tub, stall enclosure or outdoor shower and anchor the unit to the walls with his/her choice of screws or the adjustable end cap which is either spring loaded or is turned to wedge the unit in position between opposing walls. Thus, no remodeling or penetration is necessarily required. After the unit is installed between opposing walls of the bath tub or shower enclosure, the existing shower head is unscrewed from the existing wall pipe, and a sleeve tap having a diverter valve is then screwed onto the wall pipe. The removed shower head is then screwed to the diverter valve. To complete the installation, one end of a flexible hose is connected to the diverter valve on the existing wall pipe and the other end is connected to a nipple on the multiple shower head unit.

The temperature and volume of the water to the rain like shower head unit and the existing shower head is controlled by the existing shower water control unit which is used to set the water temperature and volume of water to the existing wall shower head by mixing hot and cold water.

The rain like shower head unit includes preferably a chrome plated copper and/or stainless steal pipe that, in addition to carrying water from the diverter valve to the various rain like shower heads, also functions as a support member.

Although copper or stainless steal are the preferred materials, other suitable materials such as, but not limited to, plastics may be utilized. Located in the support member is an optional diverter valve that allows a user to control the flow of water from full on to off to a rear rain like shower head while maintaining full flow to a forward rain like shower head. In addition, a diverter valve on the diverter valve allows the user to direct shower water from the existing wall shower head and the rain like shower heads on the unit simultaneously or from either the existing wall shower head or the multiple shower heads.

The foregoing has outlined, rather broadly, the preferred feature of the present invention so that those skilled in the art may better understand the detailed description of the invention that follows. Additional features of the invention and additional embodiments will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings.

FIG. 1 is a schematic diagram showing a bath tub located in an enclosure of three walls with the rain like shower head unit located between two opposing walls and connected to the wall pipe of an existing wall shower head;

FIG. 2 is a schematic top view of the shower head unit connected to the wall pipe of an existing shower head;

FIG. 3 is a schematic bottom view of the shower head unit connected to the wall pipe of an existing shower head;

FIG. 4 is a schematic view of the flexible pipe connected to the diverter valve which includes a diverted valve;

FIG. 5 is a schematic view of the adjustable end of the water carrying support member;

FIG. 6 is a side view of the shower head unit adapted to receive two shower heads and a flexible water pipe;

FIG. 7 is a side view of another embodiment where the shower head unit is adapted to receive one shower head and a flexible water pipe;

FIG. 8 is a schematic view of the mounting brackets for the shower head unit including the preferred embodiment round mounting brackets and alternative mounting bracket shape such as square mounting brackets;

FIG. 9 are views of alternate embodiments of the wall mounting positions for the shower head;

FIG. 10 is a view of an alternate embodiment of the shower head with ceiling mounting positions;

FIG. 11 is a view of an alternate embodiment of the mounting brackets for the shower head unit;

FIG. 12 is a view of the preferred nipple position and an alternate embodiment angled nipple position;

FIG. 13 is a side view of an upper horizontal overhead embodiment with an alternate embodiment that shows an attachable vertical member in two different positions;

FIG. 14 is a side view of an upper horizontal overhead embodiment;

FIG. 15 is a side view of an additional embodiment showing an upper horizontal overhead unit with alternate embodiments that shows attachable vertical members;

FIG. 16 is a side view of an additional embodiment of an upper horizontal overhead unit;

FIG. 17 is a side view of an additional embodiment of an upper horizontal overhead unit;

FIG. 18 is a side view of an alternate embodiment showing a single angled shower head coupled with a vertical unit;

FIG. 19 is a side view showing a selection of alternate embodiments of a vertical member;

FIG. 20 is a side and bottom view of an embodiment of an upper horizontal member;

FIG. 21 is a side view of an embodiment of an upper horizontal member;

FIG. 22 is a side view of an embodiment of an upper horizontal member;

FIG. 23 is a side and bottom view of an embodiment of an upper horizontal member;

FIG. 24 is a side view of an embodiment of an upper horizontal member showing an alternate method of support;

FIG. 25 is a view of various mounting embodiments; and

FIG. 26 is a bottom and top view of an alternate arrangement;

### DETAILED DESCRIPTION OF ILLUSTRATIVE EMBODIMENTS

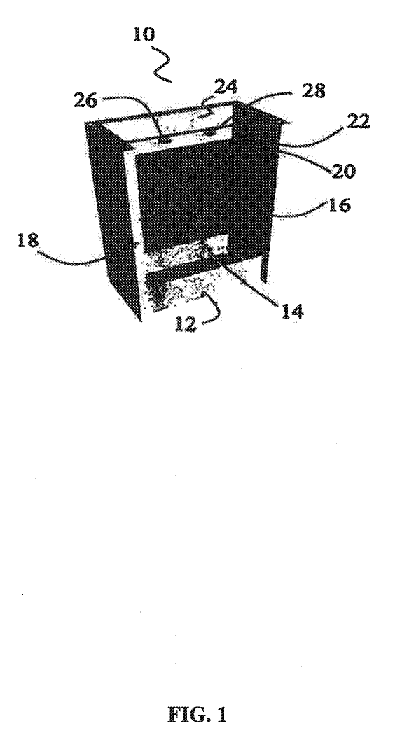

Referring to FIG. 1, there is shown a schematic diagram 10 of a bath tub located in an enclosure of three walls with the rain like shower head unit located between two opposing wall and connected to the wall pipe of an existing wall shower head. More specifically, a bath tub 12 is located in an enclosure having a rear wall 14 and two opposing side walls 16, 18 where wall 16 supports an existing wall shower head 20 threadingly connected to a wall water pipe 22 and control knobs (not shown) for controlling the pressure and temperature of water to the existing wall shower head.

The rain like shower head unit 24 is located above the existing wall shower head and is attached to opposing wall 16, 18. It is connected to the wall water pipe 22 that supplies water to the shower heads 26, 28 with a flexible water pipe.

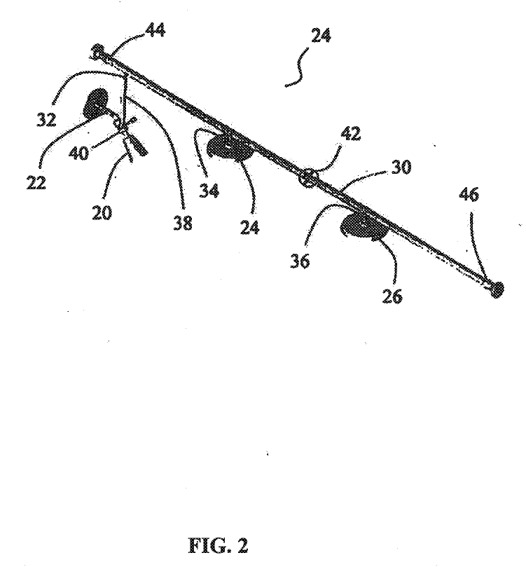

Referring to FIG. 2, there is shown a schematic top view of the rain like shower head unit connected to the wall pipe of an existing shower head. The rain like shower head unit 24 includes a chromium plated copper and/or stainless steal pipe 30 that functions as a support member and includes three nipples 32, 34, and 36. Although Pipe 30 is preferably a pipe, it is contemplated that it could be round, square or rectangular tubing. Nipple 32 is provided to be threaded to one end of the flexible water pipe 38. The other end of flexible pipe 38 is threaded to diverter valve 40 that contains a diverter valve. The diverter valve is located between the wall water pipe 22 and the existing wall shower head 20.

The diverter valve is threaded to the wall water pipe and the existing shower head is threaded to the diverter valve. The diverter valve contains a diverter valve that has two positions. A first position passes water from the wall water pipe to the existing shower head, and a second position passes water from the wall water pipe, through the flexible pipe 38 and support member 30 to the shower heads 28, 26 of the rain like shower head unit 24. Thus, the diverter valve in the diverter valve allows a user to receive shower water from the existing wall shower head or the overhead rain like shower heads 28, 26. An optional diverter valve 42 is located in support member between the two rain like shower heads 28,26 allows a user to receive shower water from only one shower head 28 or from both shower heads simultaneously. Thus, when optional diverter valve 42 is in one position, the supply of water to the rear shower head 26 is cut off, and when diverter valve 42 is in its second position shower water is supplied to both shower heads.

The support member 30 has two preferably adjustable ends 44, 46. Located between adjustable end 44 and the nipple 32 which is connected to the flexible pipe 38, and located close to nipple 32 within support member 30 is a water stop that prevents shower water from passing to the adjustable end 44 of the support member. Similarly, located between the end 46 and the nipple that is connected to the shower head 26 and close to this nipple and within the support member 30 is a water stop that prevents shower water from passing to the end 46 of the support member.

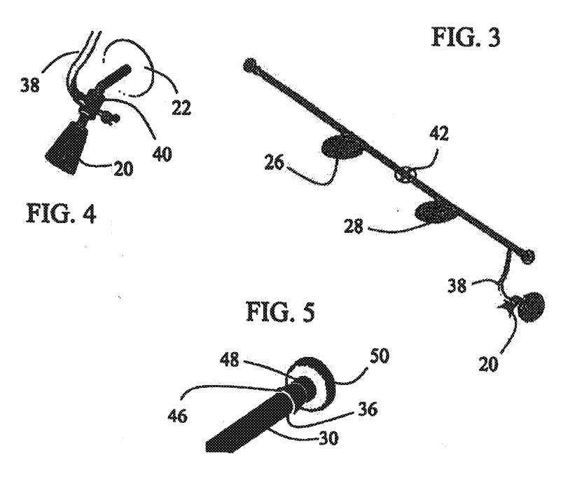

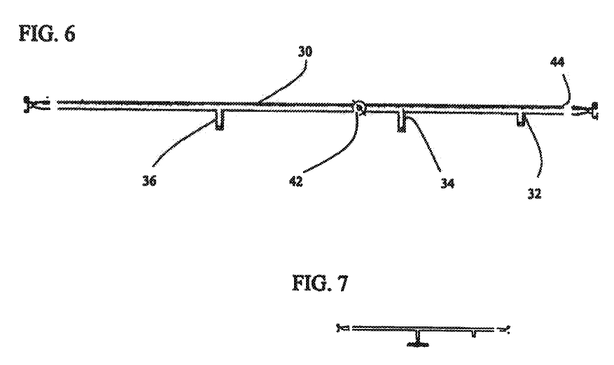

Referring to FIG. 3, there is shown a schematic bottom view of the rain like shower head unit connected to the wall pipe of an existing shower head with the flexible water conducting pipe 38 that has an inside diameter of 318 of an inch.

Referring to FIG. 4, there is shown a schematic view of the flexible pipe 38 connected to the diverter valve 40 which includes a diverter valve and is positioned between the existing wall water pipe 22 and the existing wall shower head 20. The diverter valve allows a user to selectively divert shower water from the existing wall shower head to the rain like shower heads of the rain like shower head unit 24.

Referring to FIG. 5, there is shown a schematic view of the adjustable end of the water conduction support member 30. Prior to purchasing the rain like shower unit, the distance between the opposing walls of the enclosure is measured and a support member 30 that is about one inch less than the distance between the opposing walls is selected. The end 36 of the rain like shower head support member 30 supports a thread that is connected to a threaded member 48 that is connected to an end cap 50. To attach support member 30 to opposing walls 16, 18 (see FIG. 1) of the enclosure, the support member is positioned above the existing wall shower head and threaded member 48 is turned relative to the support member until the end cap 50 is pressing snugly against the wall 18 (see FIG. 1).

In another embodiment, member 48 can be a sleeve that slidably fits over the support member and is urged by an internal spring to move an attached end cap away from the end of the support member. To install the rain like shower head unit, the installer moves the sleeve along the support member to compress the spring. The installer now positions the support member between opposing walls 16 and 18 of the enclosure and releases the sleeve to allow the compressed spring to urge the end cap to press tightly against wall 18.

In still another embodiment, the support member can be coupled to flanges that are attached to walls 16, 18 with screws and chrome plated end caps are then positioned over the flanges.

After the support member is attached to the walls, the flexible water pipe is attached to the nipple on the support member and to the diverter valve. It is understood that the outside surface of the support member 30 can have a decorative finish other than chromium such as painting, polished stainless or any other known finish.

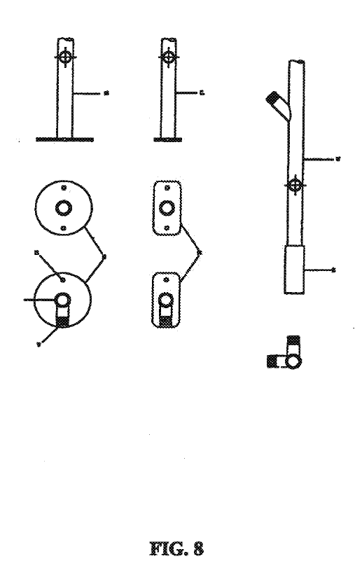

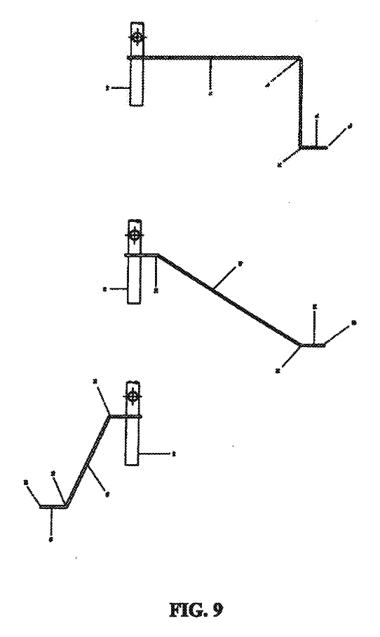

Referring to FIG. 7, there is shown a side view of another embodiment of the invention where the rain like shower head unit has one shower head and a flexible water pipe. The rain like shower head unit is not limited to one or two shower heads, but can include up to five rain like shower head that are either evenly or unevenly spaced apart.

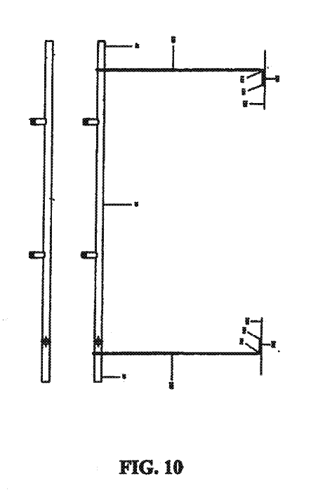

Referring to FIG. 8, there are shown mounting bracket options including round mounting bracket 50 and square mounting bracket 60 for preferably securing rain like shower head unit 10 to wall 16 and wall 18 of bath tub 12. As described previously and referring to FIG. 5, rain like shower head unit 10 was secured to wall 16. In the preferred embodiment, round mounting bracket 50 is preferably secured to wall 18 of bath tub 12 above wall water pipe 22 with screws through screw ports 52. The height at which the round mounting bracket 52 is secured to wall 18 can be adjusted to the installers or owners preference. Adjustable end 44 of support member 30 preferably inserts into notch 54 and preferably rests upon member support ledge 56 against wall 18. FIG. 8 also shows a side view 58 of support member 30 when placed and secured into round mounting bracket 50.

It is understood that in an alternate embodiment, round mounting bracket 50 can be substituted for brackets having different shapes such as square mounting bracket 60 also shown in FIG. 8. Finally, FIG. 8 also shows a side view of support member 30 when placed and secured into square mounting bracket 60.

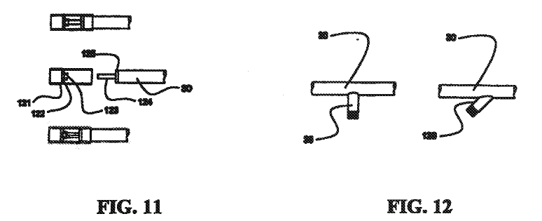

Referring to FIG. 9, there are shown alternate embodiments of rain like shower head unit 10 include three attachment methods for securing rain like shower head unit 10 to wall 18. The first alternate embodiment of rain like shower head unit 10 has an L-shaped mounting member 70 that preferably projects upward and toward wall 18 from near adjustable end 44 of rain like shower head unit 10. At point 72, L-shaped mounting member 70 angles at 90 degrees to the horizontal and projects towards wall 18. At point 74, L-shaped member 70 preferably angles at 90 degrees to the vertical and projects in the upward direction to end 78. Close to end 78 is preferably screw port 76 allowing attachment to wall 18 above water pipe 22. The second alternate embodiment of shower head unit 10 has a diagonal-shaped mounting member 80 that preferably projects upward and toward wall 18 from near adjustable end 44 of rain like shower head unit 10. At point 82, diagonal-shaped mounting member 80 preferably angles from the vertical and projects towards wall 18 upward direction. At point 84, diagonal-shaped member 80 preferably angles back towards the vertical and projects in the upward direction to end 88. Close to end 88 is preferably screw port 86 allowing attachment to wall 18 above water pipe 22. The third alternate embodiment of shower head unit 10 has a diagonal shaped mounting member 90 that preferably projects downwards and toward wall 18 from near adjustable end 44 of rain like shower head unit 10. At point 92, diagonal-shaped mounting member 90 preferably angles from the vertical and projects towards wall 18 in the downward direction. At point 94, diagonal-shaped member 90 preferably angles back towards the vertical and projects in the downward direction to end 98. Close to end 98 is preferably screw port 66 allowing attachment to wall 18 below water pipe 22.

Referring to FIG. 10, there is shown an alternate embodiment of rain like shower head unit 10 where ceiling 120 is used for securing rain like shower head unit 10. In this embodiment, rain like shower head unit 10 has mounting member 100 that preferably projects upward and toward ceiling 120 from near adjustable end 44 of rain like shower head unit 10. At point 102, mounting member 100 preferably angles at 90 degrees to the horizontal and projects to end 104. Close to end 104 is preferably screw port 106 allowing attachment to ceiling 120. Like mounting member 100, mounting member 110 preferably projects upward and toward ceiling 120 from far end 46 of rain like shower head unit 10. At point 112, mounting member 100 preferably angles at 90 degrees to the horizontal and projects to end 114. Close to end 114 is preferably screw port 116 allowing attachment to ceiling 120.

Now referring to FIG. 11, an alternate embodiment of the mounting brackets for the shower head unit is shown. Said embodiment comprises outer pipe mounting assembly 121, fastening mount plate 122, fastening nut 123, fastener 124 and end cap 125.

Now referring to FIG. 12, nipple 36 is shown in the preferred perpendicular position. Additionally, an alternate embodiment having an angled nipple 126 is shown.

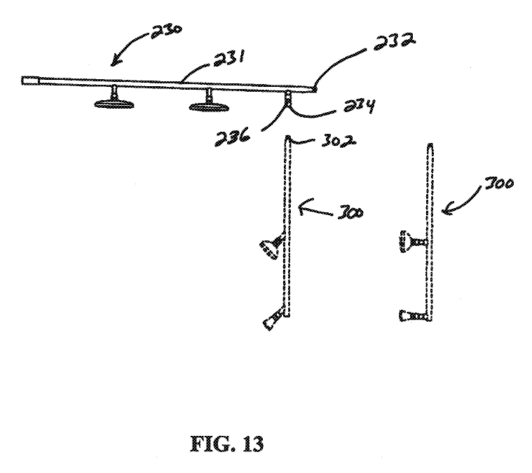

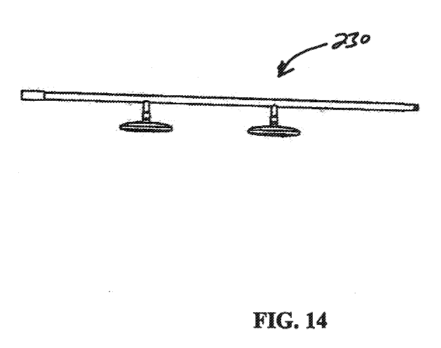

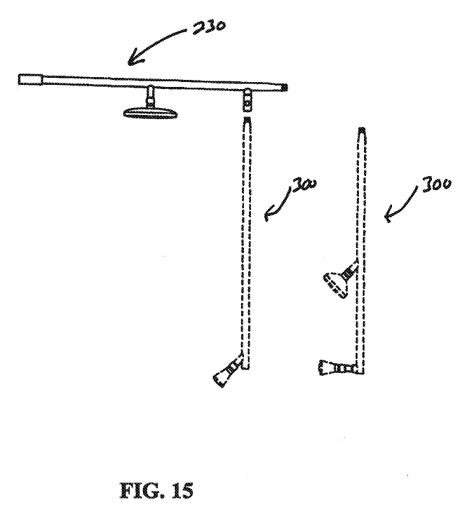

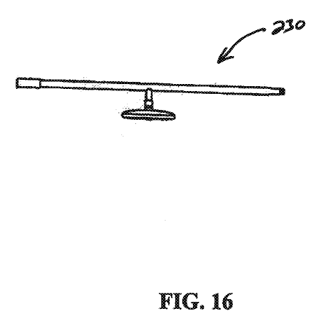

Now referring to FIG. 13, another set of alternate embodiments are shown, wherein one end 232 of the horizontal support member 231, is threaded to be received directly into an existing shower wall pipe. Additionally, a vertical body spray section 300 is shown wherein the upper end 302 thereof is threaded to be received in nipple 234. Nipple 234 incorporates a valve 236 for controlling the water flow between the overhead shower portion 230 and the vertical body spray section 300. As is shown in FIG. 14, overhead shower portion 230 may be designed to exclude valve 236 and vertical body spray section 300 in an alternate embodiment. FIGS. 15-16 show additional alternate embodiments, wherein the number of shower heads may vary.

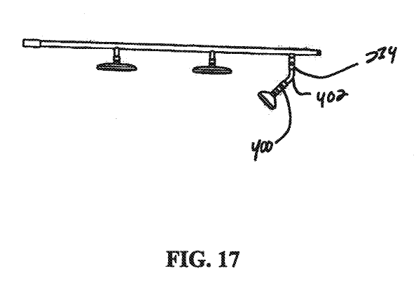

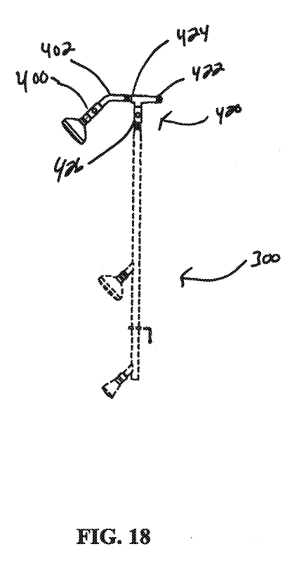

Now referring to FIG. 17, an embodiment is shown wherein a standard angled shower head 400 and neck 402 are utilized in nipple 234. FIG. 18 is an embodiment wherein only vertical body spray section 300 is utilized with a standard angled shower head 400 and neck 402. Coupler 420 connects angled shower head 400 and neck 402 with vertical body spray section 300. Coupler 420 comprises male threaded end 422 to be received within an existing shower wall pipe, female threaded end 424 for receiving the threaded end of a standard angled shower head 400 and neck 402, and a nipple portion 426 having valve 428 for receiving the threaded end of vertical body spray section 300.

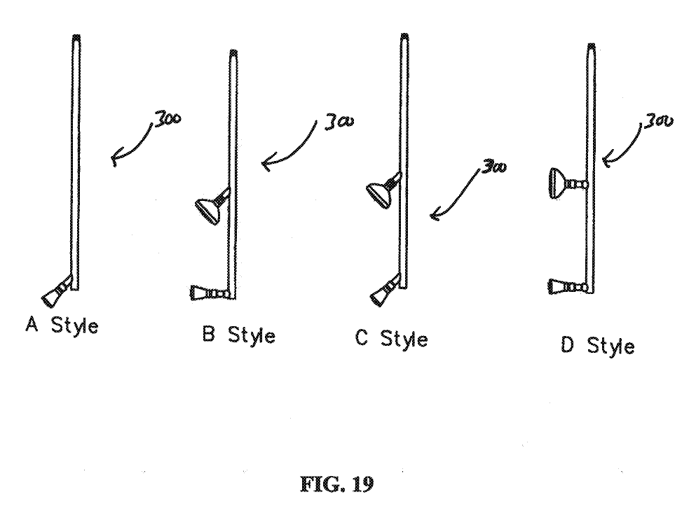

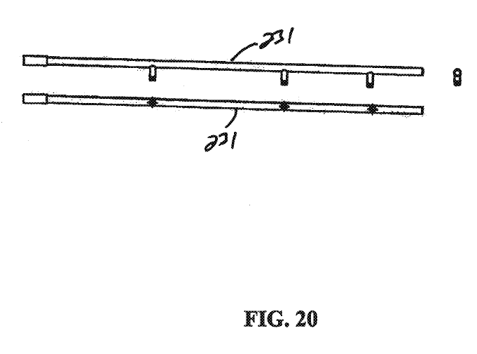

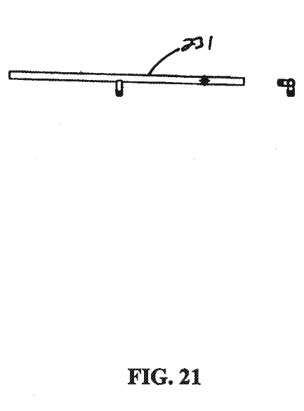

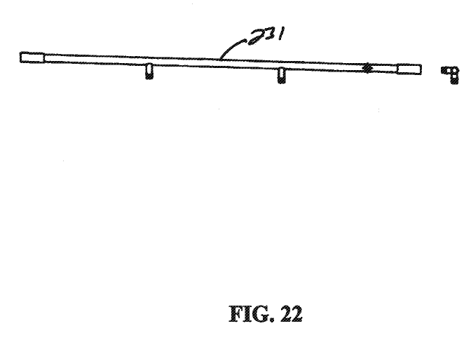

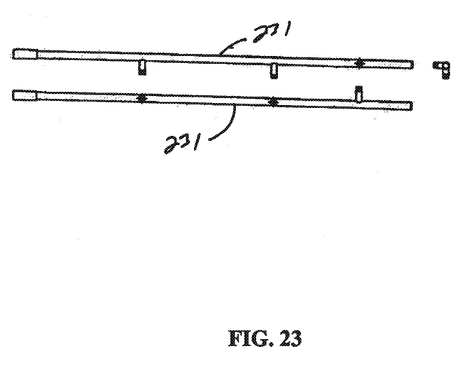

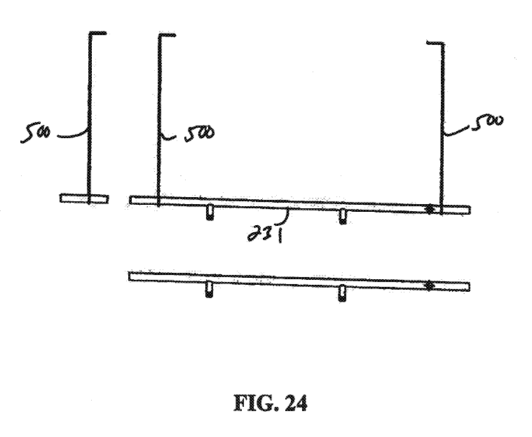

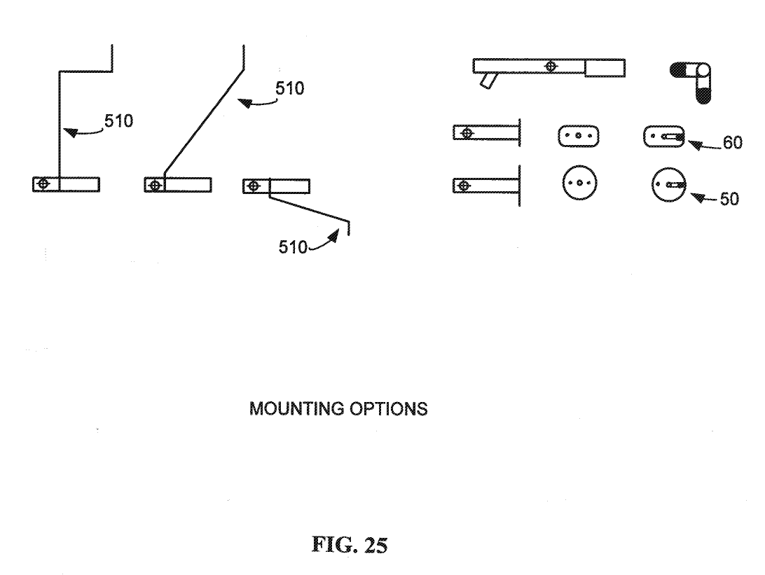

Now referring to FIG. 19, there is shown a plurality of alternate embodiments for vertical body spray section 300. FIGS. 20-23 show support members for various alternate embodiments of the overhead shower portion 230. FIGS. 24-25 show alternate mounting/supporting methods, wherein hanging members 500 can be utilized and/or mounting bracket 50 and/or square mounting bracket 60 and/or wall hanging members 510 for securing rain like shower head unit 10 to a wall or ceiling.

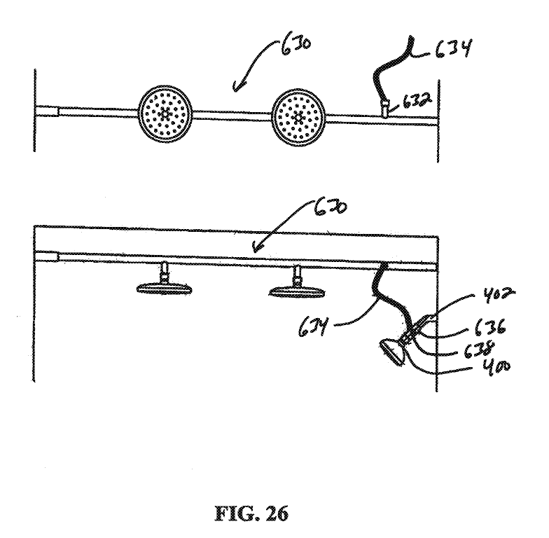

Now referring to FIG. 26, another alternate embodiment is shown wherein overhead shower portion 630 incorporates a extension 632 wherein a flexible pipe or hose 634 extends therefrom and is connected to a coupler 636. Coupler 636 serves to couple standard angled shower head 400 with neck 402 with overhead shower portion 630. Valve 638 is incorporated into coupler 636 to control water flow.

While there have been shown and described and pointed out the fundamental novel features of the invention as applied to the preferred embodiments, it will be understood that various omissions and substitutions and changes of the form and details of the apparatus illustrated and in the operation may be done by those skilled in the art, without departing from the spirit of the invention.

What is claimed:

1. A shower head unit having at least one shower head, wherein shower head is connect to a support member for an overhead shower, the support member is adapted to be positioned between opposing walls of a bath tub, stall enclosure or outdoor shower having a wall water pipe and a wall shower head attached to the wall water pipe, said support member is a pipe having first and second ends and a nipple adapted to be coupled to the wall water pipe near said first end for carrying shower water to said at least one rain like shower head and is located above the wall shower head.

2. The shower head unit of claim 1 wherein said shower head is a rain-like shower head.

3. The shower head unit of claim 1 wherein said shower head is an adjustable multi-spray shower head.

4. The shower head unit of claim 1 wherein said shower head is a standard shower head.

5. The shower head unit of claim 1 wherein said support member has a water stop located within said support member between said nipple and said first end.

6. The shower head unit of claim 5 wherein said support member is coupled to the wall water pipe for receiving shower water.

7. The shower head unit of claim 6 wherein said support member is coupled through a diverter valve to the wall water pipe for receiving shower water.

8. The shower head unit of claim 7 wherein said support member is coupled to the diverter valve with a flexible hose.

9. The shower head unit of claim 8 wherein said diverter valve controls the flow of shower water to either the wall shower head or to the at least one overhead shower head.

10. The shower head unit of claim 9 wherein said at least one overhead shower head is a first and second rain like shower head.

11. The shower head unit of claim 10 wherein said second rain like shower head is located down stream of said first rain like shower head.

12. The shower head unit of claim 11 wherein a water stop is located within the support member between said second rain like shower head and said second end of said support member.

13. The shower head unit of claim 12 wherein a diverter valve is located in said support member between said first and second rain like shower heads.

14. The shower head unit of claim 13 wherein said support member has a threaded end coupled to a threaded member provided to clamp the support member to opposing walls of a bathtub, shower enclosure or outdoor shower when the threaded member is rotated counter clockwise relative to the threaded end.

15. The shower head of claim 14 wherein an end cap is coupled to the threaded member.

16. The shower head unit of claim 13 wherein each end of said support member is coupled to a flange that is adapted to be fastened to opposing walls of a bathtub, shower enclosure or outdoor shower.

17. The shower head unit of claim 16 wherein each flange is adapted to be coupled to a wall of the bath tub, shower enclosure or outdoor shower with screws.

18. The shower head unit of claim 16 wherein each flange is covered with an end cap.

19. The shower head unit of claim 13 wherein said support member has a slidable member coupled to one end of the support member, and a spring provided to increase the length of said support member by urging said slidable member along said support member for clamping said support member between the opposing walls of a bath tub, shower enclosure or outdoor shower.

20. The shower head unit of claim 19 wherein the ends of the support member are coupled to end caps.

21. The shower head unit of claim 13 wherein the parts of the shower unit are selected from the group consisting of polished stainless, chromium plated, PVC, painted and cooper.
